(19) United States
(12) Patent Application Publication
(10) Pub. No.: US 2010/0089707 A1
(43) Pub. Date: Apr. 15, 2010

(54) PERMANENT MAGNET NOISE ISOLATOR

(75) Inventor: Minglun Qiu, Bloomfield, CT (US)

Correspondence Address: KINNEY AND LANGE PA, 312 S THIRD STREET, MINNEAPOLIS, MN, 55415, US

(73) Assignee: OTIS ELEVATOR COMPANY, Farmington, CT (US)

(21) Appl. No.: 12/524,813

(22) PCT Filed: Jan. 29, 2007
(86) PCT No.: PCT/US07/02433

§ 371 Date: Jul. 28, 2009

(51) Int. Cl. B66B 7/04; B66B 7/02

(52) U.S. Cl. 187/410; 187/409

(57) ABSTRACT

An elevator system (10) includes at least one non-contacting permanent magnet coupling (22) arranged between two elevator system components (14, 18).

### BACKGROUND

The present invention relates to a non-contacting coupler that physically isolates one component connected to the coupler from a second component connected to the coupler. More particularly, the invention relates to a coupler, which isolates an elevator car from the guide rails on which the car rides.

A typical elevator system includes an elevator car and a counterweight, each suspended on opposite ends of hoist ropes in an elevator hoistway. In some systems, the elevator car is attached to a car frame to which the hoist ropes are attached. The elevator system also includes guide rails extending the length of the hoistway and attached to opposite sides of the hoistway. A group of roller guides are attached to the elevator car or car frame and guide the car or frame up and down the hoistway along the guide rails.

There are several factors that impact the quality of the elevator car ride in elevator systems. One such factor is the total length of the hoistway. Longer hoistways require a greater number of guide rail segments stacked within the hoistway and a greater number of joints between the guide rail segments. A greater number of guide rail segments results in greater total weight of the guide rails. The increased weight of the guide rail segments causes the rails to deflect in the hoistway. Also, the joints between the guide rail segments result in discontinuities at the joints. Even slightly deflected rails and minimal discontinuity in joints cause the elevator car to vibrate and move laterally.

To minimize the adverse impact of rail imperfections on the ride quality of the elevator car, roller guide assemblies commonly include a suspension system and a damping system. However, prior roller guide assemblies have struggled with balancing the stiffness required for damping and the cushion required for suspension. Furthermore, prior systems have continued to provide a physical path through which vibration or noise can travel from one part of the elevator system to another, in particular, from the guide rails to the elevator car. In this sense, prior systems have been unable to truly isolate the elevator car from vibration or noise caused by guide rail deflection and discontinuity.

Prior elevator systems have also employed electromagnetic couplers to reduce the impact of guide rail imperfections on the ride quality of the elevator car. However, electromagnetic couplers have several disadvantages. Electromagnetic couplers are subject to failure when the power source driving the electromagnets included in such couplers fails. Although such couplers may employ failsafe methods, elevator safety is nevertheless a concern with electromagnetic couplers. Electromagnetic couplers consume extra electric energy during operation and increase the mass added to elevator systems employing such couplers. In addition, electromagnetic couplers are very costly, practically prohibiting their use in commercial elevator systems applications.

In light of the foregoing, the present invention aims to resolve one or more of the aforementioned issues that afflict elevator systems.

### SUMMARY

The present invention includes an elevator system comprising a guide, a car apparatus, and at least one non-contacting permanent magnet coupling arranged between the guide and the car apparatus.

The present invention also includes a device for coupling a first and second component of an elevator assembly, which comprises at least one non-contacting permanent magnet pair arranged between the first and second elevator assembly components. The non-contacting permanent magnet pair is configured to substantially inhibit relative movement of the first and second components in a plurality of directions, and transfer force between the first and second components.

Embodiments of the present invention are configured to provide a connection between elevator system components, between the elevator car and the guide rails, which substantially inhibit relative movement of and transfer force between the components while simultaneously substantially physically isolating the elevator car from vibrations caused by imperfections in the guide rails.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are hereafter briefly described.

FIG. 1 shows an elevator system.

FIG. 2 shows an elevator system including an embodiment of a non-contacting coupling according to the present invention.

FIG. 3 shows an exploded, detail view of the non-contacting coupling shown in the elevator system of FIG. 2.

FIG. 4 shows a detail view of an alternative embodiment of a non-contacting coupling according to the present invention.

FIG. 5 is a close-up view of the non-contacting coupling shown in FIG. 4.

### DETAILED DESCRIPTION

Efforts have been made throughout the drawings to use the same or similar reference numerals for the same or like components.

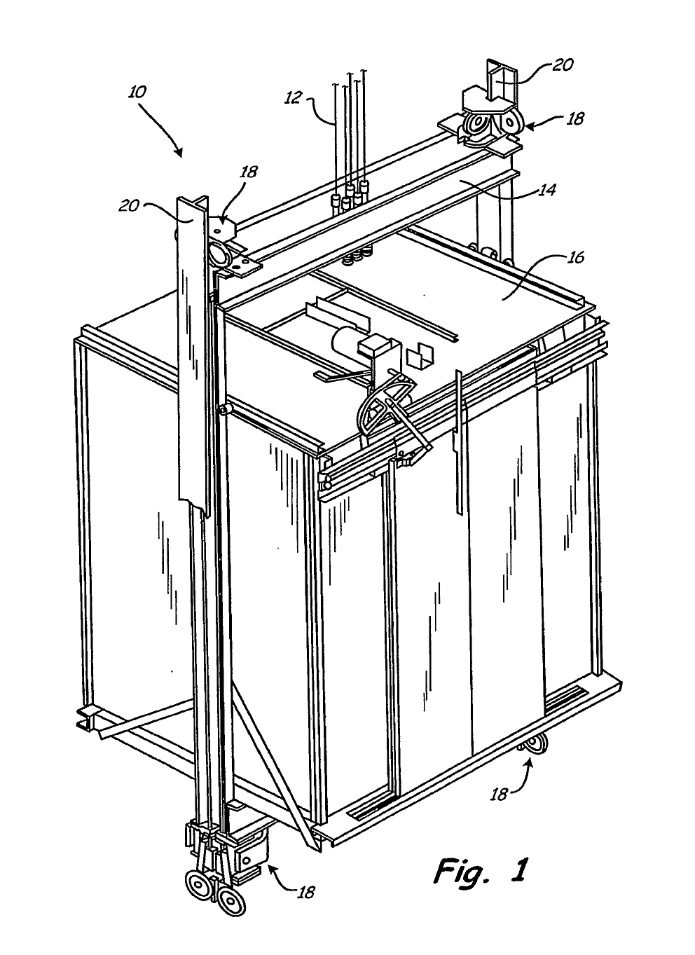

FIG. 1 shows an elevator system 10, which includes cables 12, a car frame 14, a car 16, roller guides 18, and guide rails 20. The cables 12 are connected to the car frame 14 and a counterweight inside a hoistway. The car 16, which is attached to the car frame 14, moves up and down the hoistway by force transmitted through the cables 12 to the car frame 14. The roller guides 18 are attached to the car frame 14 and guide the car frame 14 and the car 16 up and down the hoistway along the guide rails 20.

Imperfections in the guide rails 20 may affect ride quality by causing the car frame 14, and thereby the car 16, to vibrate and move inside the hoistway. There are several factors that impact the ride quality of the car 16. As previously discussed, two factors are: (a) the total length of the hoistway, which directly correlates to the potential for the segments of the guide rails 20 to deflect; and (b) the potential for discontinuities in the joints between the segments of the guide rails 20. Even slightly deflected and discontinuous guide rails 20 cause vibrations or noise, which may be transmitted through the roller guides 18 and the car frame 14 to the car 16.

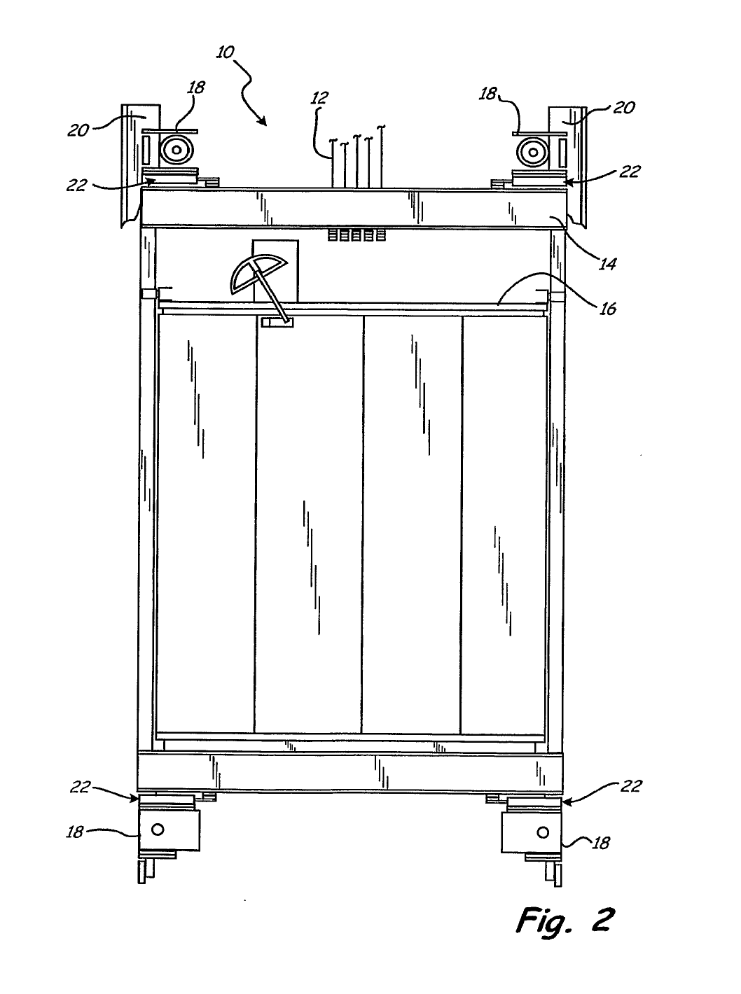

FIG. 2 shows an elevator system 10 including one embodiment of a non-contacting coupling 22 according to the present invention. In FIG. 2, elevator system 10 includes the car frame 14, the car 16, the roller guides 18, the guide rails 20, and four non-contacting couplings 22. The non-contacting couplings 22 connect the roller guides 18 to the car frame 14. The couplings 22 are configured to substantially inhibit relative movement and transfer force between the car frame 14 and the roller guides 18. Additionally, the couplings 22 substantially physically isolate the car frame, and thereby the car 16, from the roller guides 18. By arranging the couplings 22 between the car 16 and the guide rails 20, in this embodiment at the four connections between the car frame 14 and the roller guides 18, the car 16 is substantially physically isolated from disturbances caused by the guide rails 20. For example, in the elevator system 10 shown in FIG. 2, imperfections in the guide rails 20 caused by slight deflections or discontinuities cause the roller guides 18 to deflect or vibrate as they ride along the guide rails 20. However, the car 16 is substantially unaffected by such imperfections in the guide rails 20, because the couplings 22 between the car frame 14 and the roller guides 18 substantially remove a physical path through which the deflection or vibration of the roller guides 18 can travel to the car 16.

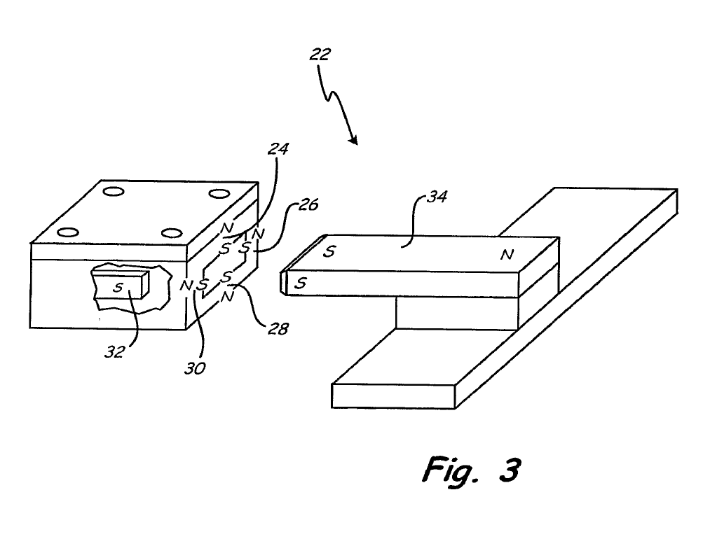

FIG. 3 shows an exploded detail view of one embodiment of one non-contacting coupling 22, which includes a first magnet 24, a second magnet 26, a third magnet 28, a fourth magnet 30, a fifth magnet 32, and a sixth magnet 34. The magnets 24-34 each have a north and a south magnetic pole. The first, second, third, fourth, and fifth magnets 24-32 may be connected to one of the roller guides 18 as shown in FIG. 2. The sixth magnet 34 may be connected to the car frame 14 also as shown in FIG. 2. When assembled, the first, second, third, and fourth magnets 24-30 are arranged around the sixth magnet 34. The south poles of the first, second, third, and fourth magnets 24-30 are arranged opposite the south pole of the sixth magnet 34. The fifth magnet 32 is arranged laterally from the end of the sixth magnet 34. The south pole of the fifth magnet 32 is arranged opposite the south pole of the sixth magnet 34.

In the arrangement shown in FIGS. 2 and 3, the non-contacting coupling 22, when assembled, substantially inhibits relative movement and transfers force between the car frame 14 and the roller guide 18, while simultaneously substantially physically isolating the car frame 14, and thereby the car 16, from vibrations in the roller guide 18. Each of the magnet pairs, for example the first magnet 24 and sixth magnet 34 or the fifth magnet 32 and the sixth magnet 34, of the coupling 22 generate magnetic fields, which oppose one another and thereby inhibit relative movement and which transfer forces in a single direction. For example, the magnetic field of the first magnet 24 repels the magnetic field of the sixth magnet 34 and thereby inhibits upward movement of the sixth magnet 34 toward the first magnet 24. At the same time, the magnetic field of the third magnet 28 also repels the magnetic field of the sixth magnet 34, thereby inhibiting downward movement of the sixth magnet 34 toward the third magnet 28. As a result, the sixth magnet 34 essentially floats between the first and third magnets 24, 28. Moreover, the sixth magnet 34 also essentially floats between the second and fourth magnets 26, 32 in the same manner.

As the sixth magnet 34 essentially floats amongst the first, second, third, and fourth magnets 24, 26, 28, 30, movement of the sixth magnet 34 is inhibited in four directions up, down, frontward, backward (i.e., movement is inhibited in two dimensions). In addition, movement of the sixth magnet 34 is also inhibited in the leftward direction of FIG. 3 by the opposing magnetic field of the fifth magnet 32. As hereafter explained, movement of the sixth magnet 34 may also be inhibited in the rightward direction (i.e., movement may also be inhibited in the third dimension).

The coupling 22 shown in FIG. 3 is configured to inhibit relative movement and transfer force in five directions (i.e., up, down, frontward, backward, and leftward). Movement and force exerted on the car in the rightward direction may also be inhibited by providing a second non-contacting coupling arranged opposite of the non-contacting coupling 22 shown in FIG. 3. An example of such an arrangement is shown FIG. 2. Therefore, the coupling 22 shown in FIG. 3 may be employed as part of a pair in which the couplings 22 are arranged opposite one another to inhibit relative movement in six directions (i.e., three dimensions) while at the same time enabling a non-contacting transfer of force between elevator system components in all six directions. The non-contacting coupling 22 also substantially physically isolates the car frame 14, and thereby the car 16, from the roller guides 18. As such, the coupling 22 is configured to remove a physical path through which vibrations in the roller guides 18 caused by imperfections in the guide rails 20 can travel to the car 16.

The repelling magnetic fields between the first and sixth magnets 24, 34 and between the third and sixth magnets 28, 34 also enables a non-contacting transfer of force in a single dimension, which may as shown be generally vertical. For example, the coupling 22 may, as shown in FIG. 2, be connected between the car frame 14 and one of the roller guides 18. As the car frame 14, and thereby the car 16, is pulled up the hoistway by the cables 12 (see FIG. 1), the magnetic field of the sixth magnet 34 upwardly pushes against the opposing magnetic field of the first magnet 24 and transfers the force the cables 12 exert on the car frame 14 and the car 16 to one of the roller guides 18. Similarly, when the car 16 is lowered in the hoistway by the cables 12, the magnetic field of the sixth magnet 34 downwardly pushes against the opposing magnetic field of the third magnet 28 and transfers the force the cables 12 exert on the car frame 14 and the car 16 to one of the roller guides 18.

Although the coupling 22 shown in FIGS. 2 and 3 includes permanent magnets arranged with opposing south poles, couplings according to the present invention also include permanent magnets arranged with opposing north poles. Furthermore, the placement of the coupling 22 on the car frame 16 and the roller guide 18 and the number, size, or shape of the permanent magnets 24-34 of the coupling 22 may vary across different embodiments of the present invention. Embodiments of the present invention also do not require that the coupling 22 be connected between the car frame 14 and the roller guide 18. For example, a non-contacting coupling according to the present invention could connect the roller guides 18 to the car 16 directly. In another embodiment, a non-contacting coupling according to the present invention could be connected between the car frame 14 and the car 16.

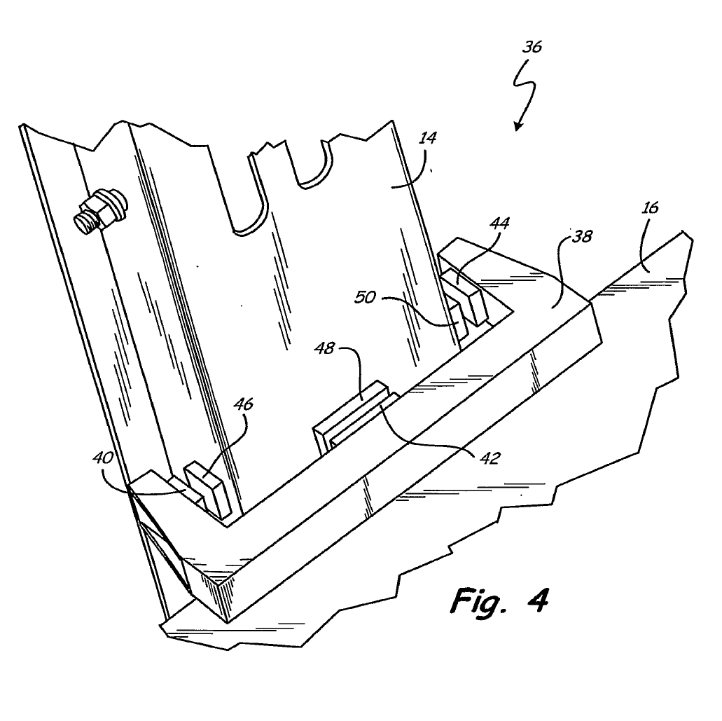

FIG. 4 shows a detail view of an alternative non-contacting coupling 36 according to the present invention, which includes a bracket 38, a first magnet 40, a second magnet 42, a third magnet 44, a fourth magnet 46, a fifth magnet 48, and a sixth magnet 50. The car 16 is attached to the car frame 14, in part, by the non-contacting coupling 36. The bracket 38 is attached to the top of the car 16 opposite the car frame 14. The first, second, and third magnets 40, 42, 44 are attached to the bracket 38 on the car 16. The fourth, fifth, and sixth magnets 46, 48, 50 are attached to the car frame 14.

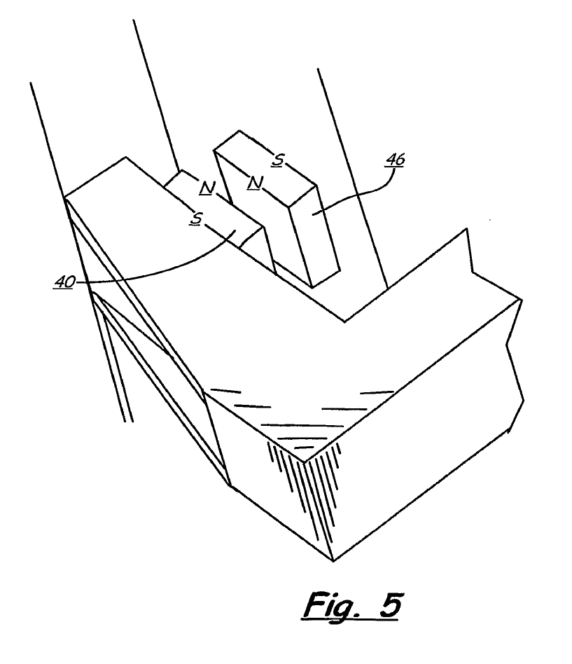

The six permanent magnets 40-50 each have north and south magnetic poles that are arranged so that various magnet pairs repel each other. For example, the opposed north poles of the first magnet 40 and the fourth magnet 46 are shown in FIG. 5. Similarly, the north pole of the second magnet 42 may be arranged opposite the north pole of the fifth magnet 48. The north pole of the third magnet 44 may be arranged opposite the north pole of the sixth magnet 50.

The non-contacting coupling 36 steadies the car 16 with respect to the car frame 14 in the hoistway by providing a non-contacting connection between the top of the car 16 and the car frame 14. The non-contacting coupling 36 may work in conjunction with other conventional contact connections between the car frame 14 and the car 16, for example between the bottom of the car 16 and the car frame 14. Accordingly, the non-contacting coupling 36 may not completely isolate the car 16 from vibrations. Nevertheless, even in such instances in which the car 16 is not completely isolated from vibrations, the non-contacting coupling 36 significantly reduces vibrations caused by imperfections in the guide rails from traveling through the car frame 14 to the car 16 by physically isolating at least the top of the car 16 from the car frame 14, and thereby substantially removing a physical path through which vibrations may travel through the car frame 14 to the top of the car 16.

In the arrangement shown in FIG. 4, the coupling 36 is configured to substantially inhibit relative movement and transfer force between the car frame 14 and the top of the car 16. Each of the magnets in a magnet pair, for example the first magnet 40 and fourth magnet 46 or the second magnet 44 and the fifth magnet 48, of the coupling 36 generates a magnetic field that opposes the magnetic field of the other magnet in the pair. As a result, the magnet pair inhibits relative movement and transfers force in a single dimension. For example, the magnetic field of the first magnet 40 repels the magnetic field of the fourth magnet 46, thereby inhibiting forward movement of the fourth magnet 46 in the direction of the first magnet 40. Similarly, the magnetic field of the fourth magnet 46 repels the magnetic field of the first magnet 40, thereby inhibiting rearward movement of the first magnet 40 in the direction of the fourth magnet 46.

The non-contacting connection created by the opposing magnetic fields of the first and fourth magnets 40, 46 also physically isolates the top of the car 16 from the car frame 14 in a single dimension. The non-contacting coupling 36 is connected between the car frame 14 and the car 16. As the car frame 14 and the car 16 are pulled up (or down) the hoistway, the car frame 14 may experience vibrations caused by imperfections in the guide rails (see, e.g., FIG. 1), which vibrations are physically transmitted by the roller guides (see, e.g., FIG. 1) to the car frame 14. However, the non-contacting coupling 36 substantially inhibits the vibrations in the car frame 14 from reaching the top of the car 16. For example, vibrations causing the car frame 14 to move forward may be isolated by the opposing magnetic fields of the first magnet 40 and the fourth magnet 46 and/or by the opposing magnetic fields of the third magnet 44 and the sixth magnet 50.

A variety of permanent magnets may be appropriate for use in non-contacting couplings according to the present invention. Permanent magnets are readily available and come in a variety of shapes, sizes, and strengths. For example, a rare-earth magnet such as a neodymium magnet is appropriate for use in embodiments of the present invention. Neodymium magnets are made of a combination of neodymium, iron, and boron (NdFeB) and are commercially available in column, wafer, ring, ball, and tube shapes as well as in many other shapes. Where appropriate and depending on the intended application, a variety of other types of permanent magnets, including samarium-cobalt, may be used in non-contacting couplings according to the present invention.

Embodiments of the non-contacting coupling according to the present invention and elevator systems including such non-contacting couplings provide several advantages over prior methods and apparatuses for improving the ride quality in elevator cars. Embodiments of the present invention are configured to provide a connection between elevator system components, between the elevator car and the guide rails, which substantially inhibit relative movement and transfer force between the components while simultaneously substantially physically isolating the elevator car from vibrations caused by imperfections in the guide rails. Furthermore, embodiments of the present invention reduce the necessity for complex suspension and damping systems located between the car and the guide rails and remove the difficulty of balancing the cushioning requirements of suspension systems with the stiffness requirements of damping systems.

The aforementioned discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended scope of the invention as set forth in the claims that follow.

The specification and drawings are accordingly to be regarded in an illustrative manner and are not intended to limit the scope of the appended claims. In light of the foregoing disclosure of the present invention, one versed in the art would appreciate that there may be other embodiments and modifications within the scope of the present invention. Accordingly, all modifications attainable by one versed in the art from the present disclosure within the scope of the present invention are to be included as further embodiments of the present invention. The scope of the present invention is to be defined as set forth in the following claims.

Although the present invention has been described with reference to preferred embodiments, workers skilled in the art will recognize that changes may be made in form and detail without departing from the spirit and scope of the invention.

1. An elevator system, the system comprising:
a guide;
a car apparatus; and
at least one non-contacting permanent magnet coupling arranged between the guide and the car apparatus.

2. The system of claim 1, wherein the at least one non-contacting permanent magnet coupling is configured to substantially isolate the car apparatus from vibrations caused by the guide.

3. The system of claim 2, wherein the car apparatus comprises a car frame to which is attached a car, wherein the car frame is slidably connected to the guide, and wherein the at least one non-contacting permanent magnet coupling is arranged between the car and the car frame.

4. The system of claim 3, wherein the at least one non-contacting permanent magnet coupling comprises:
first and second non-contacting permanent magnet coupling members arranged between the top of the car and the car frame.

5. The system of claim 4, wherein the first and second non-contacting permanent magnet coupling members comprise:
a first, second, and third permanent magnet each with north and south poles and each connected to the top of the car; and
a fourth, fifth, and sixth permanent magnet each with north and south poles and each connected to the car frame, and
wherein either:
(a) the north poles of the first, second, and third permanent magnets are arranged opposite the north poles of the fourth, fifth, and sixth permanent magnets, or
(b) the south poles of the first, second, and third permanent magnets are arranged opposite the south poles of the fourth, fifth, and sixth permanent magnets.

6. The system of claim 2, wherein the guide comprises one or more roller guides, wherein the car apparatus comprises a car frame to which is attached a car, and wherein the at least one non-contacting permanent magnet coupling is arranged between the one or more roller guides and the car frame.

7. The system of claim 6, wherein the at least one non-contacting permanent magnet coupling comprises:
a first, second, third, fourth, and fifth magnet each with north and south poles and each connected to at least one of the one or more roller guides; and
a sixth magnet with north and south poles and connected to the car frame, and
wherein either:
(a) the north poles of the first, second, third, fourth, and fifth magnets are arranged opposite the north pole of the sixth magnet, or
(b) the south poles of the first, second, third, fourth, and fifth magnets are arranged opposite the south pole of the sixth magnet.

8. The system of claim 6, wherein the plurality of non-contacting permanent magnet couplings each further comprise:
a first, second, third, fourth, and fifth magnet each with north and south poles and each connected to the car frame; and
a sixth magnet with north and south poles and connected to at least one of the one or more roller guides, and
wherein either:
(a) the north poles of the first, second, third, fourth, and fifth magnets are arranged opposite the north pole of the sixth magnet, or
(b) the south poles of the first, second, third, fourth, and fifth magnets are arranged opposite the south pole of the sixth magnet.

9. The system of claim 1, wherein the car apparatus comprises a car frame to which is attached a car, wherein the car frame is slidably connected to the guide, and wherein the at least one non-contacting permanent magnet coupling is arranged between the car and the car frame.

10. The system of claim 9, wherein the at least one non-contacting coupling is configured to transfer force between the car frame and the car.

11. The system of claim 10, wherein the at least one non-contacting permanent magnet coupling comprises:
first and second non-contacting permanent magnet coupling members arranged between the top of the car and the car frame.

12. The system of claim 11, wherein the first and second non-contacting permanent magnet coupling members comprise:
a first, second, and third permanent magnet each with north and south poles and each connected to the top of the car; and
a fourth, fifth, and sixth permanent magnet each with north and south poles and each connected to the car frame, and
wherein either:
(a) the north poles of the first, second, and third permanent magnets are arranged opposite the north poles of the fourth, fifth, and sixth permanent magnets, or
(b) the south poles of the first, second, and third permanent magnets are arranged opposite the south poles of the fourth, fifth, and sixth permanent magnets.

13. The system of claim 1, wherein the guide comprises one or more roller guides, wherein the car apparatus comprises a car frame, and wherein the at least one non-contacting permanent magnet coupling is arranged between the one or more roller guides and the car frame.

14. The system of claim 13, wherein the at least one non-contacting permanent magnet coupling is configured to transfer force between the one or more roller guides and the car frame.

15. The system of claim 14, wherein the at least one non-contacting permanent magnet coupling comprises:
a first, second, third, fourth, and fifth magnet each with north and south poles and each connected to at least one of the one or more roller guides; and
a sixth magnet with north and south poles and connected to the car frame, and
wherein either:
(a) the north poles of the first, second, third, fourth, and fifth magnets are arranged opposite the north pole of the sixth magnet, or
(b) the south poles of the first, second, third, fourth, and fifth magnets are arranged opposite the south pole of the sixth magnet.

16. The system of claim 14, wherein the at least one non-contacting permanent magnet coupling comprises:
a first, second, third, fourth, and fifth magnet each with north and south poles and each connected to the car frame; and
a sixth magnet with north and south poles and connected to at least one of the one or more roller guides, and
wherein either:
(a) the north poles of the first, second, third, fourth, and fifth magnets are arranged opposite the north pole of the sixth magnet, or
(b) the south poles of the first, second, third, fourth, and fifth magnets are arranged opposite the south pole of the sixth magnet.

17. A device for coupling a first and second component of an elevator assembly, the device comprising:
at least one non-contacting permanent magnet pair arranged between the first and second elevator assembly components and configured to: (a) substantially inhibit relative movement of the first and second components in a plurality of directions; and (b) transfer force between the first and second components.

18. The device of claim 17, wherein the first and second components are selected from a group consisting of a car and any component connected between the car and one or more guide rails.

19. The device of claim 18, wherein the at least one non-contacting permanent magnet pair comprises:
a plurality of first magnets with north and south poles connected to the first component; and
a plurality of second magnets with north and south poles connected to the second component, and
wherein either:
(a) the north poles of the first magnets are arranged opposite the north poles of the second magnets, or
(b) the south poles of the first magnets are arranged opposite the south poles of the second magnets.

20. The device of claim 18, wherein the at least one non-contacting permanent magnet pair comprises:
a first, second, third, fourth, and fifth magnet each with north and south poles and each connected to the first component; and
a sixth magnet with north and south poles and connected to the second component, and
wherein either:
(a) the north poles of the first, second, third, fourth, and fifth magnets are arranged opposite the north pole of the sixth magnet, or
(b) the south poles of the first, second, third, fourth, and fifth magnets are arranged opposite the south pole of the sixth magnet.

21. The device of claim 18, wherein the at least one non-contacting permanent magnet pair comprises:
a first, second, and third magnet each with north and south poles and each connected to the first component; and
a fourth, fifth, and sixth magnet each with north and south poles and each connected to the second component, and
wherein either:
(a) the north poles of the first, second, and third magnets are arranged opposite the north poles of the fourth, fifth, and sixth magnets, or
(b) the south poles of the first, second, and third magnets are arranged opposite the south poles of the fourth, fifth, and sixth magnets.
